(19) United States
(12) Patent Application Publication
(10) Pub. No.: US 2006/0140633 A1
(43) Pub. Date: Jun. 29, 2006

(54) Systems and methods for optical pump redundancy

(75) Inventor: Brian Chaput, Plano, TX (US)

Correspondence Address: PERKINS COLE LLP, 101 JEFFERSON DRIVE, MENLO PARK, CA, 94025, US

(73) Assignee: Sanmina-SCI Corporation

(21) Appl. No.: 11/025,341

(22) Filed: Dec. 28, 2004

(51) Int. Cl. H04J 14/02

(52) U.S. Cl. 398/92

(57) ABSTRACT

These systems and methods advantageously provide redundant optical pumping for an amplification system thereby providing safeguards for optical communications. A plurality of optical pump lasers generate a plurality of initial optical signals. A plurality of splitters split the initial optical signals generated from at least one of the optical pump lasers to form split optical signals. A plurality of couplers couple the split optical signals from one of the optical pump lasers with another one of the split optical signals from another of the optical pump lasers to form a plurality of pump optical signals from a plurality of redundant optical paths. By coupling pump optical signals from a plurality of optical pump lasers over redundant optical paths, there is no single point of failure. As a result, failure in any single component or optical path will not damage or degrade the optical amplifier.

### BACKGROUND

1. Field of the Invention

The present invention relates to optical systems, and more particularly, to systems and methods for optical pump redundancy within an optical amplification system.

2. Description of the Prior Art

Fiber optic communications has become ubiquitous. Fiber optic communication systems can be commonly found in military aircraft and emergency response systems as well as trans-oceanic telecommunications systems. However, a single point of failure within the fiber optic system may cripple or terminate necessary communications. The costs to access trans-oceanic telecommunications systems in order to replace optical system components can be prohibitive. Notwithstanding cost increases, however, the consequence of communications failure within military aircraft and emergency response systems may be tragic.

In order to avoid a single point of failure, redundant optical paths have been developed. Unfortunately, costs may increase in return for limited improvements in system reliability. FIG. 1 is a block diagram of an optical pump system in the prior art. This system can be found in some erbium doped fiber amplifiers (EDFAs) which are common components found in many fiber optic communications systems.

In an EDFA, a section of an optical fiber is doped with erbium. A pump optical signal raises the energy level of the dopants. Once the optical communications signal passes through the erbium doped fiber, the dopants release optical energy at the same wavelength as the optical communications signal thereby amplifying the optical communications signal.

In FIG. 1, each optical pump laser 110 and 120 generates an initial optical signal. The coupler 130 first couples the initial optical signals and then splits the coupled initial optical signals into two separate pump optical signals. The multiplexers 140 and 150 are wavelength division multiplexers, each of which multiplexes one of the pump optical signals with one redundant optical communications signal into optical data paths 160 and 170, respectively. An EDFA, not shown in FIG. 1, may then receive the multiplexed optical communications signal.

In this example of the prior art, the initial optical signals generated by the two optical pump lasers 110 and 120 have been coupled and split by a single coupler 130. The single coupler 130 represents a possible single point of failure. As a result, if the coupler 130 fails, even if the optical pump lasers 110 and 120 remain active, the optical communications signal will not be amplified because the pump optical signals will not cause the dopants to release the necessary optical energy. The coupler 130 is a single point of failure upon which the entire optical amplification system may rely.

### SUMMARY OF INVENTION

The invention addresses the above problems by providing systems and methods for operating an optical amplification system using redundant pumping. A plurality of optical pump lasers generates a plurality of initial optical signals. A plurality of splitters split the initial optical signals generated from at least one of the optical pump lasers to form split optical signals. A plurality of couplers couple the split optical signals from one of the optical pump lasers with another one of the split optical signals from another of the optical pump lasers to form a plurality of pump optical signals from a plurality of redundant optical paths.

In some embodiments, a multiplexer multiplexes at least one pump optical signal with an input optical signal into an optical fiber. In some embodiments, the optical fiber comprises a rare earth doped fiber. In some embodiments, the optical fiber comprises erbium doped fiber.

In some embodiments, a monitoring device monitors an input optical signal and a controlling device controls the generation of at least one initial optical signal based upon the monitoring device's monitoring of the input optical signal. In some embodiments, a monitoring device monitors an output optical signal and a controlling device controls the generation of at least one initial optical signal based upon the monitoring device's monitoring of the output optical signal.

In some embodiments, at least one of the splitters comprises a polarization maintaining splitter. In some embodiments, at least one of the splitters has a split ratio of 50:50. In some embodiments, at least one of the couplers comprises a polarization maintaining coupler. In some embodiments, at least one of the couplers comprises a polarization maintaining directional coupler. One of the couplers may comprise a polarization beam combiner. In some embodiments, one of the initial optical signals operates at a wavelength of 980 nanometers. In some embodiments, one of the initial optical signals operates at a wavelength of 1480 nanometers. In some embodiments, one of the initial optical signals is orthogonal to a polarization of one of the other initial optical signals. In some embodiments, there is a polarization scrambling device that scrambles a polarization of one of the initial optical signals after the initial optical signal is generated but before the initial optical signal is split.

These systems and methods advantageously provide redundant optical pumping for an amplification system thereby providing safeguards for optical communications. By coupling pump optical signals from a plurality of optical pump lasers over redundant optical paths, there is no single point of failure. As a result, failure in any single component or optical path will not damage or degrade the optical amplifier. Moreover, by coupling pump optical signals from a plurality of optical pump lasers over redundant optical paths, even multiple points of failure may not degrade or damage the optical amplifier.

### BRIEF DESCRIPTION OF THE DRAWINGS

FIG. 1 is a block diagram of an optical pump system in the prior art.

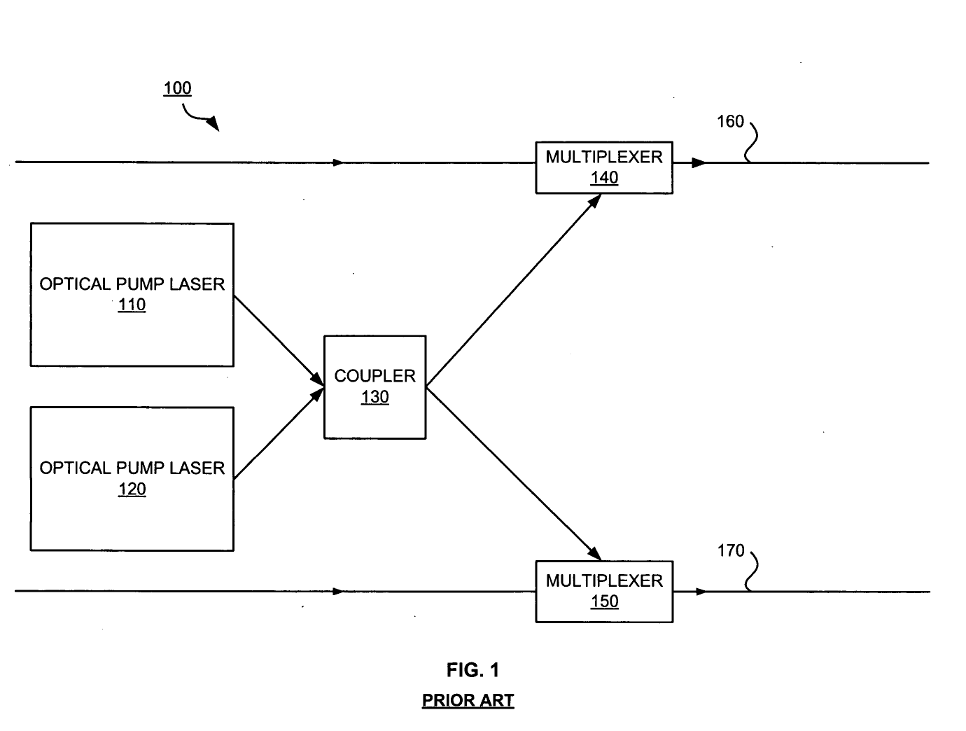

FIG. 2 is a block diagram of a redundant optical pump system in an exemplary implementation of the invention.

FIG. 3 is a flowchart for a redundant optical pump system in an exemplary implementation of the invention.

FIG. 4 is a flowchart for a redundant optical pump system in another exemplary implementation of the invention.

FIG. 5 is an illustration depicting a redundant optical amplification system in an exemplary implementation of the invention.

FIG. 6 is a flowchart for a redundant optical amplification system in an exemplary implementation of the invention.

### DETAILED DESCRIPTION OF THE INVENTION

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

Optical signal amplification is a necessary component of many fiber optic communications systems. In optical signal amplification, a signal is amplified so that the original signal does not attenuate to a point where communications diminish or terminate. It would be advantageous, especially in time sensitive communications or when access to the fiber optic communications system is limited, to introduce a system that would allow multiple optical pumps to combine their signals for the purposes of optical amplification in such a way that it eliminates all single points of failure, thereby reducing maintenance and replacement costs as well as increasing reliability.

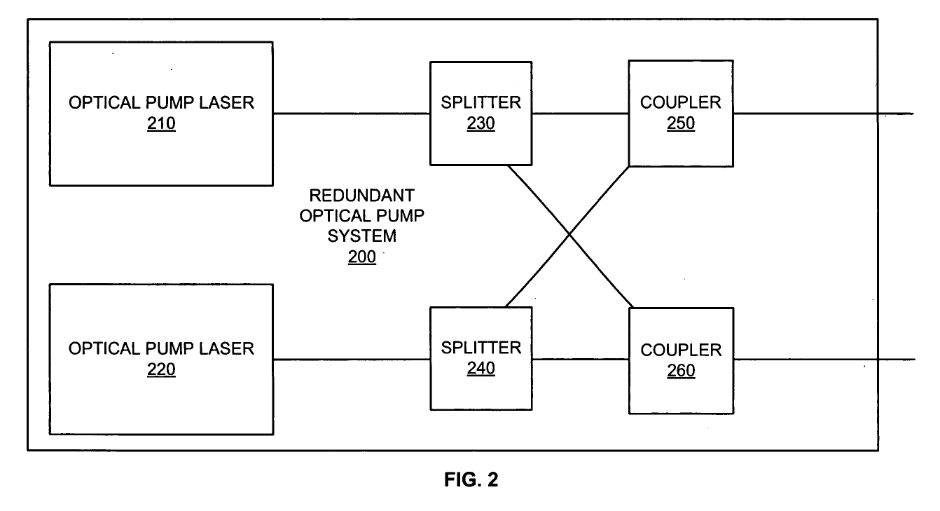

FIG. 2 is a block diagram of a redundant optical pump system in an exemplary implementation of the invention. The redundant optical pump system 200 is any multiple optical pump system configured to generate two or more optical signals without a single point of failure. FIG. 2 depicts an embodiment with pairs of optical pump lasers, splitters, and couplers. The redundant optical pump system 200 includes two optical pump lasers 210 and 220, two splitters 230 and 240, and two couplers 250 and 260. In some embodiments, there may be a plurality of optical pump lasers, splitters, and couplers configured to result in redundant optical paths.

Optical pump lasers 210 and 220 each generate an initial optical signal. Splitters 230 and 240 receive and split the initial optical signals. A splitter is an optical device configured to split optical signals. In an example, the optical pump laser 210 generates a first initial optical signal, and the optical pump laser 220 generates a second initial optical signal. Splitter 230 receives and splits the first initial optical signal into two split optical signals. Similarly, splitter 240 receives and splits the second initial optical signal into split optical signals.

Couplers 250 and 260 then receive and couple the split optical signals. In an example, the coupler 250 couples a split optical signal from splitter 230 with a split optical signal from splitter 240 to form a first pump optical signal. Similarly, the coupler 260 couples a split optical signal from splitter 240 with a split optical signal from splitter 230 to form a second pump optical signal.

In this example, since the first pump optical signal and the second pump optical signal both comprise split similar optical signals from different optical pump lasers, they are redundant. Further, since there are multiple data paths from multiple optical pump lasers within the redundant optical pump system 200, there is no single point of failure. Therefore, advantageously, a safeguard in the redundant optical pump system 200 is reliably secured.

Another embodiment includes a plurality of optical paths. In this example, a plurality of couplers each couple two or more split optical signals with at least two of the split optical signals generated by different optical pump lasers to create pump optical signals over a plurality of optical paths. In this embodiment, similar to the example depicted in FIG. 2, redundant optical pump lasers generate redundant pump optical signals without a single point of failure.

Those skilled in the art will recognize that the optical paths may comprise any light traversable media, including, but not limited to, fiber, waveguide, free space, or a crystal structure, including, but not limited to, sapphire. Similarly, the medium between components may not necessarily be the same medium as the medium between other components within the same system.

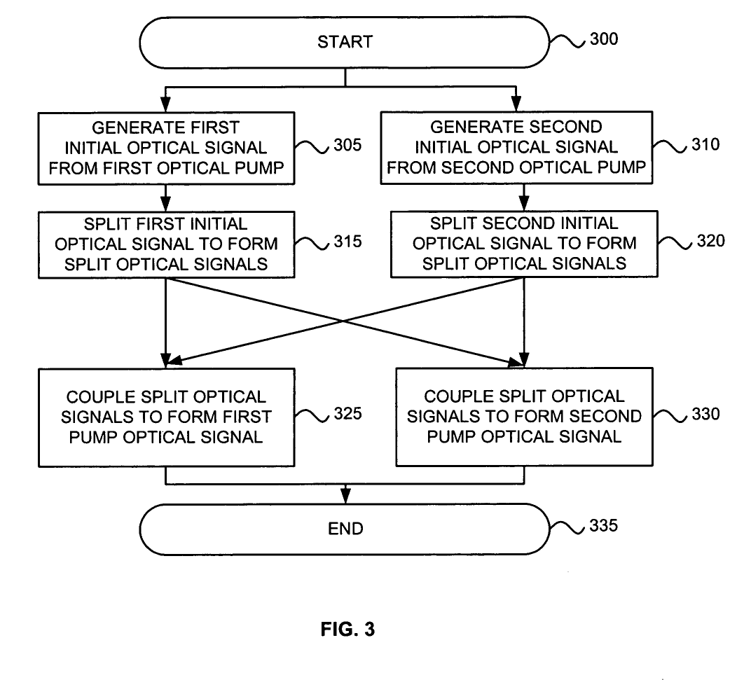

FIG. 3 is a flowchart for a redundant optical pump system in an exemplary implementation of the invention. FIG. 3, similar to FIG. 2, is an example of the invention with pairs of optical pump lasers, splitters, and couplers. In some embodiments, there may be a plurality of optical pump lasers, splitters, and couplers configured to result in redundant optical paths.

FIG. 3 begins in step 300. In step 305, an optical pump laser 210 generates a first initial optical signal. Similarly, in step 310, an optical pump laser 220 generates a second initial optical signal. In these examples, the first initial optical signal and the second initial optical signal would both be generated at the same wavelength.

In step 315, the splitter 230 splits the first initial optical signal to form split optical signals. In step 320, the splitter 240 splits the second initial optical signal to form split optical signals. In step 325, the coupler 250 receives and couples one split optical signal from each of the splitters 230 and 240 to form the first pump optical signal. In step 330, the coupler 260 receives and couples the other split optical signal from each of the splitters 230 and 240 to form the second pump optical signal. In these examples, the first pump optical signal and the second pump optical signal maintain the same wavelengths and are thereby redundant to each other. FIG. 3 ends in step 335.

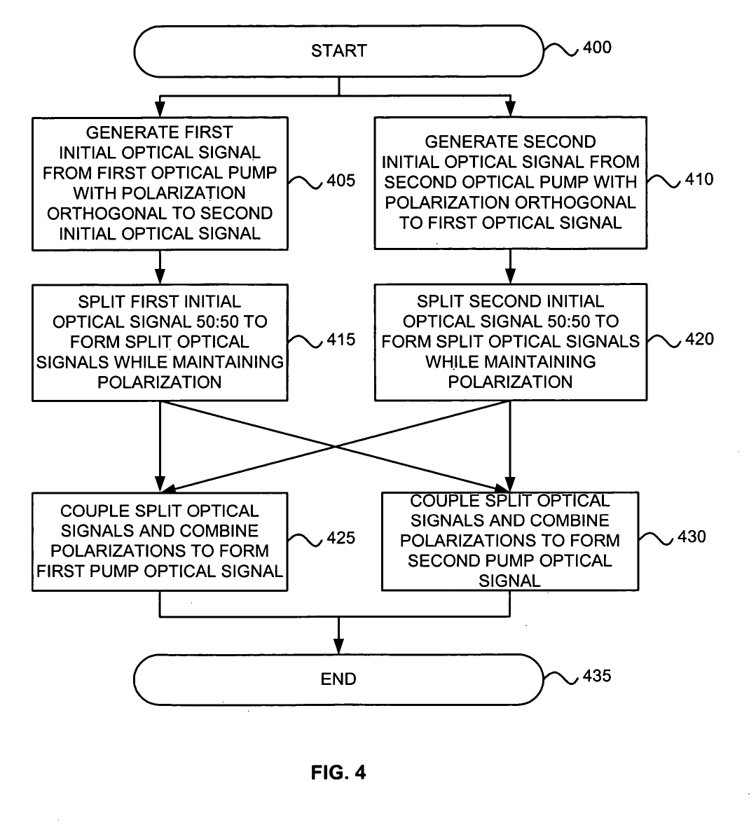

FIG. 4 is a flowchart for a redundant optical pump system in another exemplary implementation of the invention. FIG. 4, similar to FIG. 3 and FIG. 2, is an example of the invention with pairs of optical pump lasers, splitters, and couplers.

FIG. 4 begins in step 400. In step 405, an optical pump laser 210 generates a first initial optical signal with polarization orthogonal to a second initial optical signal. Similarly, in step 410, an optical pump laser 220 generates the second initial optical signal with polarization orthogonal to the first initial optical signal. In another embodiment, a polarization scrambling device, not shown in FIG. 2, receives and scrambles the polarization of the first and second initial optical signals. In some embodiments, the wavelengths of all of the initial optical signals are equal. In another embodiment, the optical pump lasers 210 and 220 generate the initial optical signals at a wavelength of 980 nanometers. In another embodiment, the optical pump lasers 210 and 220 generate the initial optical signals at a wavelength of 1480 nanometers.

In step 415, splitter 230 receives and splits the first initial optical signal by a split ratio of 50:50 to form split optical signals which maintain the first initial optical signal's polarization. Similarly, in step 420, splitter 240 receives and splits the second initial optical signal by a ratio of 50:50 to form split optical signals which maintain the second initial optical signal's polarization. In an example, at least one of the splitters 230 or 240 comprises a polarization-maintaining splitter.

In step 425, coupler 250 receives and couples one split optical signal from each splitter 230 and 240 to form the first pump optical signal. Further, the split optical signals' respective polarizations are combined within the first pump optical signal. Similarly, in step 430, coupler 260 receives and couples the other split optical signal from each splitter 230 and 240 to form the second pump optical signal. Further, the split optical signals' respective polarizations are combined within the second pump optical signal. In this example, combining the polarization of each split optical signal results in increased energy across two or more polarizations within a single pump optical signal. In another embodiment, at least one of the couplers 250 or 260 comprises a polarization maintaining coupler. In this example, the polarization of the coupled split optical signals is maintained in the pump optical signal. In another embodiment, at least one of the couplers 250 or 260 comprises a polarization maintaining directional coupler. FIG. 4 ends in step 455.

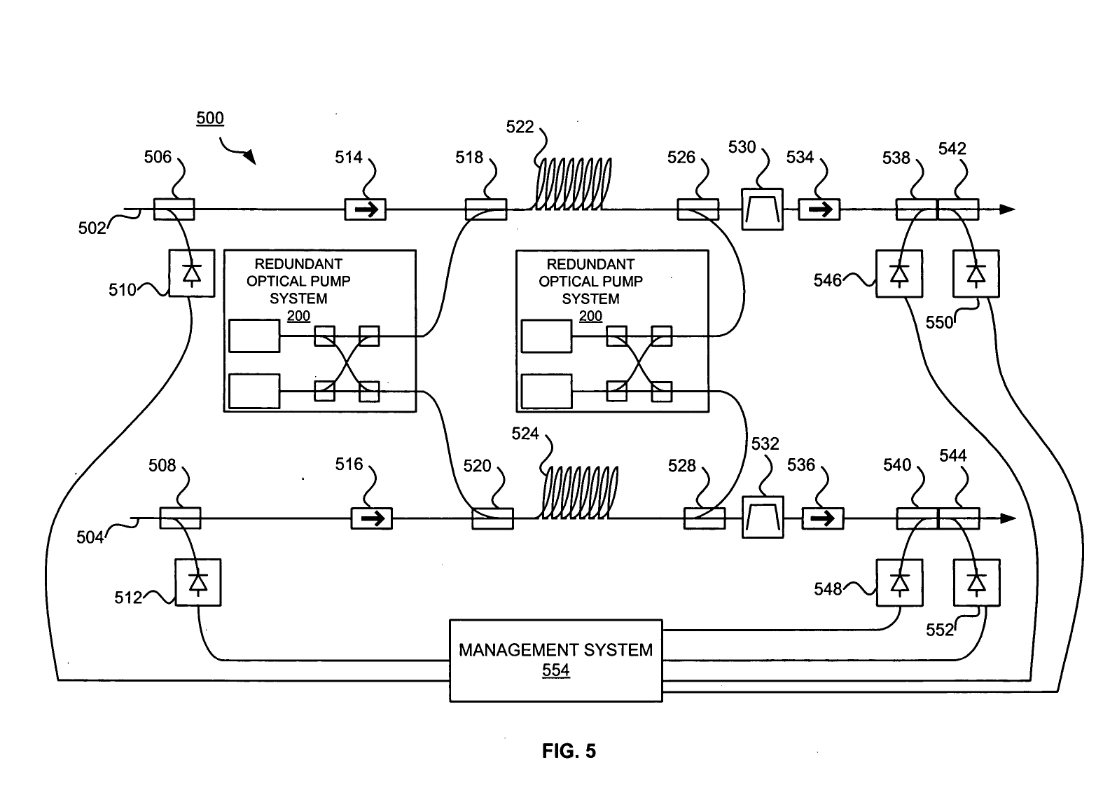

FIG. 5 is an illustration depicting a redundant optical amplification system in an exemplary implementation of the invention. The redundant optical amplification system 500 includes two optical data paths 502 and 504, wavelength division multiplexers 518, 520, 526, and 528, splitters 506, 508, 538, 540, 542, and 544, isolators 514, 516, 534, and 536, redundant optical pump systems 200, optical segments 522 and 524, amplified spontaneous emission (ASE) noise rejection filters 530 and 532, photodiodes 510, 512, 546, 548, 550, and 552, and management system 554.

In an example, an input optical signal enters the optical data path 502. In some embodiments, the optical data path 502 may comprise an optical fiber. A splitter splits the input optical signal. Photodiode 510 receives one of the split input optical signals and generates a signal which indicates the strength of the output optical signal. The photodiode 510 signal may be subsequently monitored by management system 554. The management system 554 may comprise a monitoring device and a controlling device.

An isolator 514 isolates the signal before wavelength division multiplexer 518 multiplexes the input optical signal with a pump optical signal generated by redundant optical pump system 200. The generation of the pump optical signal in the redundant optical pump system 200 is discussed above in FIG. 2. Wavelength division multiplexer 526 also multiplexes the input optical signal with a pump optical signal generated by another redundant optical pump system 200. In this example, the input optical signal becomes an output optical signal after the input optical signal is multiplexed with a pump optical signal by wavelength division multiplexer 526.

The amplification may occur in the optical segment 522. In some embodiments, the optical segment 522 is an optical fiber. In some embodiments, the optical segment 522 is a rare earth doped fiber, including, but not limited to, erbium doped fiber or gallium nitride fiber. The output optical signal is the amplified input optical signal before the ASE noise rejection filter 530 filters the signal. Isolator 534 receives and isolates the output optical signal.

Splitter 538 splits the output optical signal. Photodiode 546 receives one of the split output optical signals and generates a signal which indicates the strength of the output optical signal. The photodiode 546 signal may be subsequently monitored by management system 554. Similarly, splitter 542 splits the output optical signal. Photodiode 550 receives one of the split output optical signals and generates a signal which indicates the strength of the output optical signal. The photodiode 550 signal may be subsequently monitored by management system 554. In another embodiment, the management system 554 may also control the strength of the pump optical signals based on the monitored input optical signal or output optical signal in order to increase or decrease amplification as needed.

Those skilled in the art will recognize that the functions and components of optical data path 502 are mirrored in redundant optical data path 504. Further, those skilled in the art will recognize that the signal path through the redundant optical amplification system and its individual components depicted in FIG. 5, may comprise any light traversable media, including, but not limited to, a fiber, waveguide, free space, or crystal structure, including, but not limited to, sapphire. Similarly, the medium between components may not necessarily be the same medium as the medium between other components within the same system.

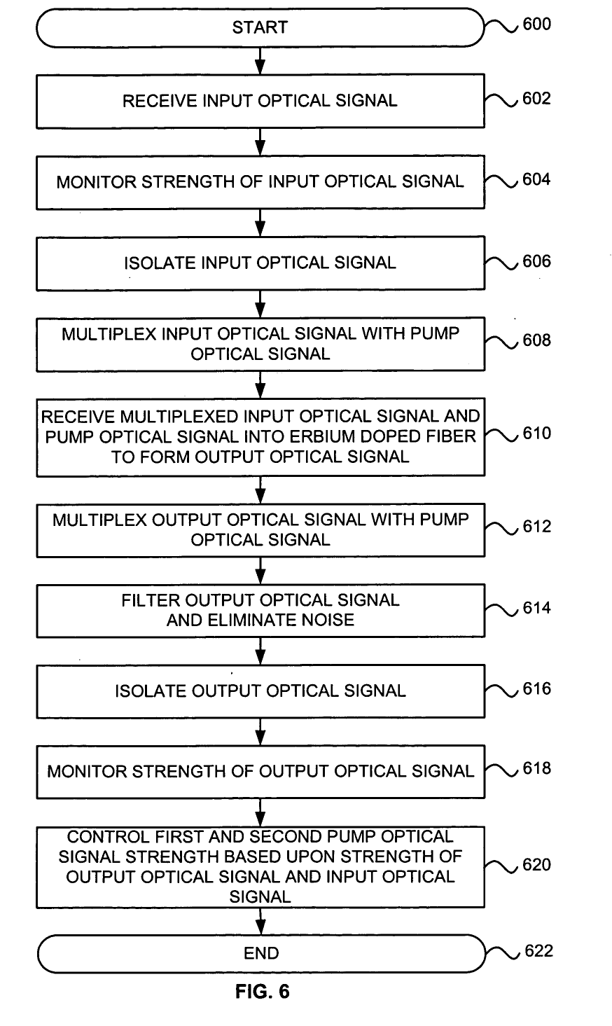

FIG. 6 is a flowchart for a redundant optical amplification system in an exemplary implementation of the invention. FIG. 6 begins in step 600. In step 602, the optical data path 502 receives an input optical signal. In step 604, the management system 554 monitors the strength of the input optical signal through photodiode 510. In an example, a splitter 506 splits the input optical signal. Photodiode 510 receives one of the split input optical signals and generates a signal which is received by the management system 554. The management system 554 monitors the strength of the optical input signal at splitter 506 through the photodiode 510.

In step 606, isolator 514 isolates the input optical signal. In step 608, the wavelength division multiplexer 518 multiplexes the input optical signal with a pump optical signal generated from the redundant optical pump system 200. In one embodiment, the redundant optical pump system generates the pump optical signal at a wavelength of 980 nanometers. In another embodiment, the redundant optical pump system generates the pump optical signal at a wavelength of 1480 nanometers.

In step 610, the optical segment 522 receives the multiplexed input optical signal. In step 612, the wavelength division multiplexer 526 multiplexes the input optical signal with a pump optical signal generated from the redundant optical pump system 200. In an example, once the input optical signal is amplified by the optical segment 522, the input optical signal becomes an output optical signal. In step 614, ASE noise rejection filter 530 filters the output optical signal. In step 616, the isolator 534 isolates the output optical signal.

In step 618, the management system 554 monitors the strength of the output optical signal at splitters 538 and 542. In an example, the management system 554 is coupled to the photodiodes 546 and 550. The splitters 538 and 542 each split the output optical signal and send one of the split output optical signals to photodiodes 546 and 550, respectively. The photodiodes 546 and 550 generate a signal that indicates the strength of the output optical signal. The management system 554 monitors the signals of the photodiodes 546 and 550.

In step 620, the management system 554 controls the first and second pump optical signal strength based upon the strength of the output optical signal and the input optical signal. In these examples, the management system 554 may control strength of the pump optical systems 200 by controlling the redundant optical pump systems 200. The management system 554 may control the strength of the pump optical signals based upon the input and output optical signals. FIG. 6 ends at step 622.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for operating an optical amplification system using redundant pumping, the method comprising:
generating a plurality of initial optical signals from a plurality of optical pump lasers;
splitting each of the initial optical signals to form split optical signals; and
coupling each of the split optical signals from one of the optical pump lasers with another one of the split optical signals from another one of the optical pump lasers to form a plurality of pump optical signals from redundant optical paths.

2. The method of claim 1 further comprising multiplexing at least one pump optical signal with an input optical signal.

3. The method of claim 2 further comprising:
monitoring the input optical signal to determine the input optical signal strength; and
controlling the generation of at least one of the initial optical signals based upon the input optical signal strength.

4. The method of claim 2 wherein receiving the multiplexed signal is performed by an optical segment.

5. The method of claim 4 wherein the optical segment comprises a rare earth doped fiber.

6. The method of claim 1 further comprising:
monitoring an output optical signal to determine an output optical signal strength; and
controlling the generation of at least one of the initial optical signals based upon the output optical signal strength.

7. The method of claim 1 wherein a polarization of at least one initial optical signal is maintained within at least one split optical signal.

8. The method of claim 1 wherein upon splitting at least one initial optical signal, the split ratio comprises 50:50.

9. The method of claim 1 wherein a polarization of at least one split optical signal is maintained in at least one pump optical signal.

10. The method of claim 1 wherein coupling each of the split optical signals further comprises combining at least one polarization of at least one split optical signal from one of the optical pump lasers with at least one polarization of another split optical signal from another one of the optical pump lasers.

11. The method of claim 1 wherein at least one initial optical signal operates at a wavelength of 980 nanometers.

12. The method of claim 1 wherein at least one initial optical signal operates at a wavelength of 1480 nanometers.

13. The method of claim 1 wherein a polarization of at least one initial optical signal is orthogonal to at least one other initial optical signal.

14. The method of claim 1 further comprising scrambling a polarization of at least one initial optical signal.

15. The method of claim 1 wherein the redundant optical paths comprise an optical fiber.

16. The method of claim 1 wherein the redundant optical paths comprise a waveguide.

17. The method of claim 1 wherein the redundant optical paths comprise free space.

18. An optical amplification system using redundant pumping, the optical amplification system comprising:
a plurality of optical pump lasers configured to generate a plurality of initial optical signals;
a plurality of splitters configured to split the initial optical signals generated from at least one optical pump laser to form split optical signals; and
a plurality of couplers configured to couple the split optical signals from one of the optical pump lasers with another one of the split optical signals from another of the optical pump lasers to form a plurality of pump optical signals from a plurality of redundant optical paths.

19. The optical amplification system of claim 18 further comprising a multiplexer configured to multiplex at least one pump optical signal with an input optical signal.

20. The optical amplification system of claim 19 further comprising:
a monitoring device configured to monitor the input optical signal; and
a controlling device configured to control the generation of at least one initial optical signal based upon the monitoring device's monitoring of the input optical signal.

21. The optical amplification system of claim 19 further comprising an optical segment configured to receive a multiplexed signal from the multiplexer.

22. The optical amplification system of claim 21 wherein the optical segment comprises a rare earth doped fiber.

23. The optical amplification system of claim 18 further comprising:
a monitoring device configured to monitor an output optical signal; and
a controlling device configured to control the generation of at least one initial optical signal based upon the monitoring device's monitoring of the output optical signal.

24. The optical amplification system of claim 18 wherein one of the splitters comprises a polarization maintaining splitter.

25. The optical amplification system of claim 18 wherein one of the splitters comprises a split ratio of 50:50.

26. The optical amplification system of claim 18 wherein one of the couplers comprises a polarization maintaining coupler.

27. The optical amplification system of claim 18 wherein one of the couplers comprises a polarization maintaining directional coupler.

28. The optical amplification system of claim 18 wherein one of the couplers further comprises a polarization beam combiner.

29. The optical amplification system of claim 18 wherein one of the initial optical signals operates at a wavelength of 980 nanometers.

30. The optical amplification system of claim 18 wherein one of the initial optical signals operates at a wavelength of 1480 nanometers.

31. The optical amplification system of claim 18 wherein a polarization of one of the initial optical signals is orthogonal to a polarization of one of the other initial optical signals.

32. The optical amplification system of claim 18 further comprising a polarization scrambling device configured to scramble a polarization of one of the initial optical signals after the initial optical signal is generated but before the initial optical signal is split.

33. The optical amplification system of claim 18 wherein the plurality of optical paths comprise an optical fiber.

34. The optical amplification system of claim 18 wherein the plurality of optical paths comprise a waveguide.

35. The optical amplification system of claim 18 wherein the plurality of optical paths comprise free space.
